(19) United States
(12) Patent Application Publication
(10) Pub. No.: US 2010/0097812 A1
(43) Pub. Date: Apr. 22, 2010

(54) Structure of the decoration lamp string

(76) Inventor: Hung-Huei Cheng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,912

(22) Filed: Oct. 16, 2008

(51) Int. Cl. F21V 21/00

(52) U.S. Cl. 362/382

(57) ABSTRACT

A new structure of decoration lamp string includes a changeable frame having the elements of an upper support, a lower support and several frame rods. The upper and lower supports are all set with jointing rods and jointing seat, and are sleeve-connected to from a stretchable shape in relative direction. The jointing seat is used to separately connect-set the pivoting parts in both ends of each frame rods on the pivoting grooves of the jointing seat to form a rotatable status. By utilizing the relative expansion and contraction between the upper and lower supports, each frame rod is braced to form the three-dimensional circular frames with each kind of varied shapes. And, it can further link and set the lamp strings on each frame rods to form the decoration lamp strings with three-dimensional frame modeling.

### PRIOR ART OF THE INVENTION

For the usage of the decoration lamp string, it is ordinarily seen that the whole decoration lamp string was suspended or hung up in the Christmas tree or wrapped in the frames with different modeling to demonstrate the special decoration effects. Although the utilization of frames to connect and set the decoration lamp strings is a good conception and has very good effect, the current seen decoration lamp strings generally adopt the stationary three-dimensional modeling design and thus create a problem due to that stationary outlook, that is, the oversized volume will cause the requirement of larger space in the delivery and storage. For the delivery, it increases the delivery cost, and it is not able to be stored easily for the storage sake. These all reveal the disadvantages of this kind of frames in the stationary typed decoration lamp strings and really wait to be improved.

### SUMMARY OF THE INVENTION

The present invention is a kind of new structure of the decoration lamp string, which mainly utilizes the relative expansion and contraction between the upper and lower supports such that each frame rod is braced to form a three-dimensional frame with each kind of varied shapes. While not used, the upper and lower supports can be stretched to their maximum lengths and let each frame rods restore their original strip shapes such that the whole frame of decoration lamp string forms a tied shape. It can largely reduces the frame volume and thus solve the flaws in the frame of known decoration lamp string in the prior art.

### BRIEF DESCRIPTION OF THE DRAWINGS

FIG. 1 is a three dimensional outside appearance drawing of the assembled structure in the present invention.

FIG. 2 to 3 are implementation diagrams of the braced frames in the present invention.

FIG. 4 is a modified embodiment drawing of the present invention.

FIG. 5 is an implementation diagram of the frame connected and set with the lamp strings in the present invention.

### DETAILED DESCRIPTION OF THE PREFERRED EMBODIMENT

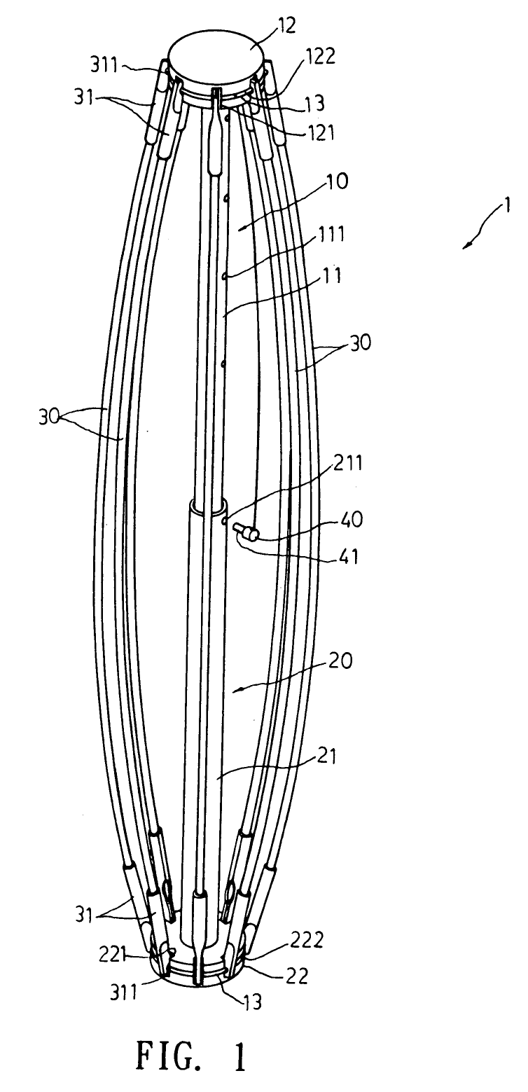

Please refer to FIG. 1. The present invention is a new structure of decoration lamp string. The frame 1 is composed of elements of an upper support 10, a lower support 20 and several frame rods 30 made of plastic material or glass fiber and a wedged plug 40. The upper support 10 and lower support 20 are separately formed by jointing rods 11, 21 with one of their ends fix-connected with a jointing seat. There are several matching holes 111 set on the rod surface of the joint rod 11 by specific interval. And, the jointing rod 21 of the lower support is set with a wedge-buckled hole 211 on the rod surface close to its top end. There are multiple pivoting grooves 121, 221 are set in the jointing seat 12, 22 by equal distance, and positioning ring grooves 122, 222 are formed in the center of the ring surface. The multiple frame rods have equal numbers with the pivoting grooves. Both ends of each frame rod 30 are fix-connected a pivoting part 31 equipped with the jointing hole 311. The wedge plug 40 can be set in the jointing seats 12 or 22 by the strings with its outside diameter of the plug rod 41 slightly smaller than the matching hole 111 and wedge-buckled hole 211. The jointing rods 11, 21 in the upper and lower supports are sleeve-jointed. Then, the pivoting parts 31 in both ends of each frame rods 30 are separately put in the pivoting grooves 121, 221 of the jointing seat in the upper and lower supports. Furthermore, the positioning strip 13 is penetrated from the positioning ring grooves 122, 222 through the jointing hole 311 then fasten-jointed to complete the assembly of the frame 1.

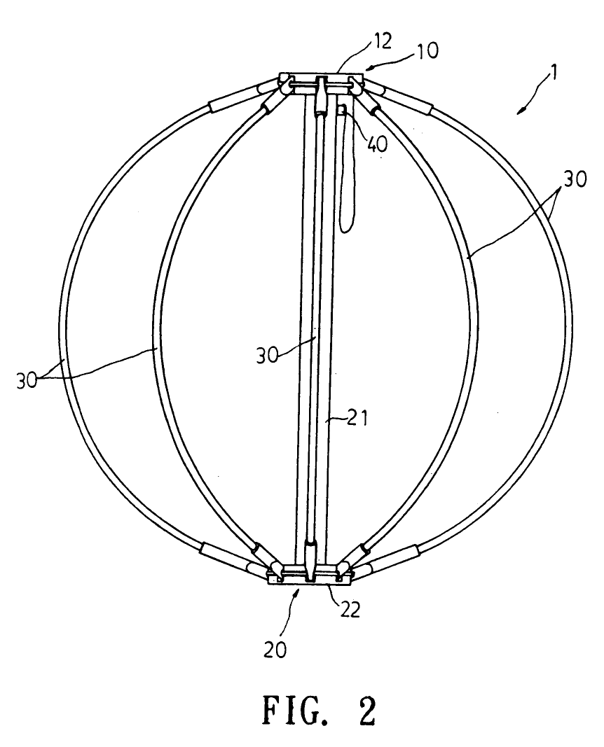

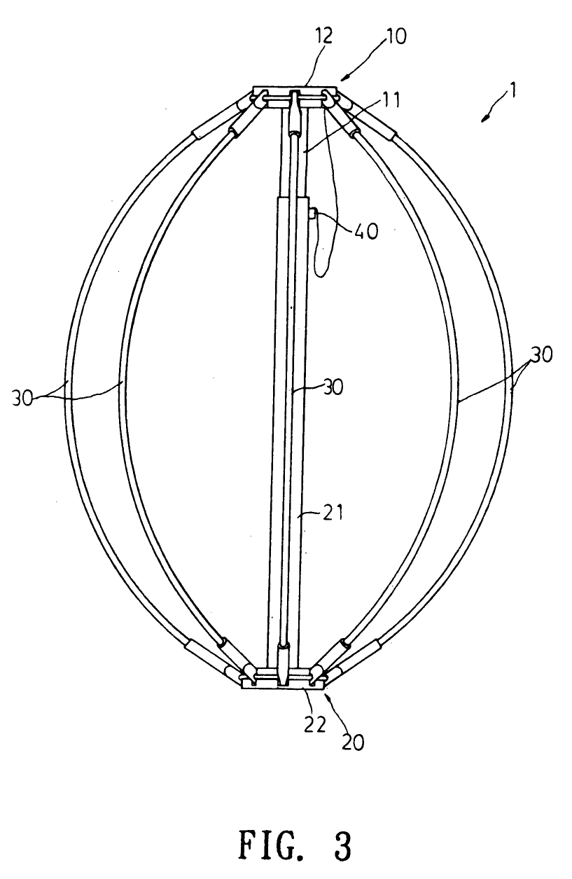

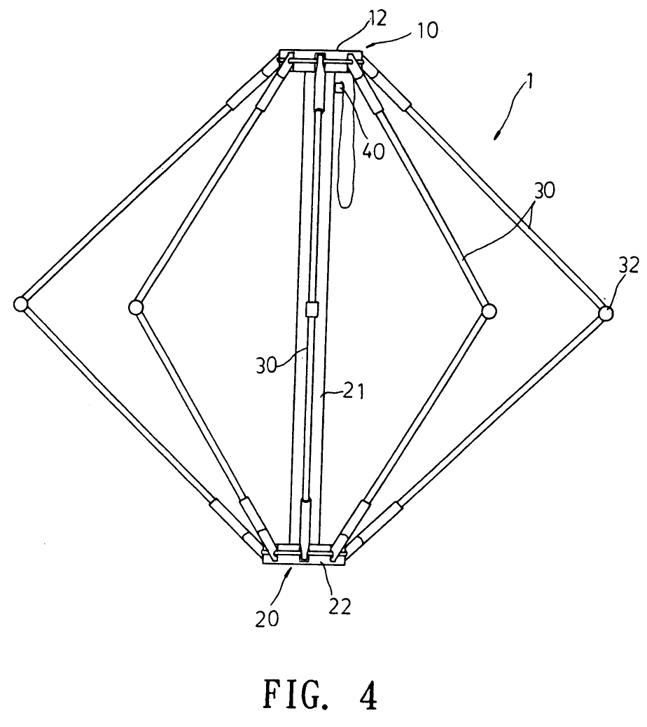

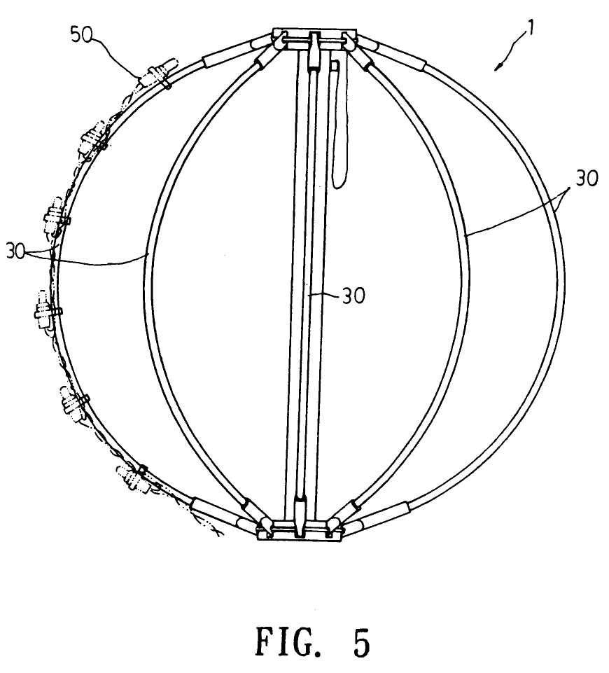

Please refer to those shown in FIGS. 2 and 3. While suppressing the jointing rods 11, 21 to let these two jointing rods sleeve-fit completely, each frame rod 30 is braced outwardly to form the three-dimensional circular frame shapes. And, the wedge plug 40 is inserting in the wedge-buckling hole 211 and matching holes 111 to let the jointing rods 11, 21 be sleeve-positioned. By utilizing the wedge-buckling of the wedge-buckled hole 211 with matching holes 111 at different positions, it can let each frame rod 30 be braced with different kinds of three-dimensional circular frame shapes. Please refer further to FIG. 4. Each frame rod 30 can use a movable joint 31 or a plug-connecting method to assemble-connect two sections of rod bodies each equipped with separate pivoting parts 31 then form a movable bending shape, and can let each frame rods 30 to be bent then formed a three dimensional frame with diamond shape. Please refer further to FIG. 5. It can further link and set the lamp strings 50 on each frame rods 30 to form the decoration lamp strings with three-dimensional frame modeling.

I claim:

1. A new structure of decoration lamp string having a frame including an upper support, a lower support and several frame rods, the upper and lower supports being all set with jointing rods and jointing seat, and the jointing seat used to separately connect-set the pivoting parts in both ends of each frame rods on the pivoting grooves of the jointing seat to form a movable shape, and by utilizing the relative expansion and contraction between the upper and lower supports such that each frame rod is braced to form the three-dimensional frames with each kinds of varied shapes.

2. A new structure of decoration lamp string as claimed in claim 1, wherein the jointing rod in the upper support is set with several matching holes, and the jointing rod of the lower support is set with a wedge-buckled hole close to its top end and a wedged plug can be set accordingly to let the matching holes and wedge-buckled hole be positioned.

3. A new structure of decoration lamp string as claim in claim 1, wherein the frame rod can use a movable joint or a plug-connecting method to assemble-connect two sections of rod bodies each equipped with separate pivoting parts then form a movable bending shape, and can let each frame rods to be bent then formed a three dimensional frame with diamond shape.
